(19) United States
(12) Patent Application Publication
(10) Pub. No.: US 2002/0008484 A1
(43) Pub. Date: Jan. 24, 2002

(54) Traction control system for a rail vehicle

(76) Inventors: Stefan Menth, Wettingen (CH); Urs Ehrler, Gebenstorf (CH)

Correspondence Address: BURNS DOANE SWECKER & MATHIS L L P, POST OFFICE BOX 1404, ALEXANDRIA, VA, 22313-1404, US

(21) Appl. No.: 09/860,436

(22) Filed: May 21, 2001

(30) Foreign Application Priority Data
May 20, 2000 (DE) 100 25 104.8

(51) Int. Cl. H02P 7/00

(52) U.S. Cl. 318/432

(57) ABSTRACT

A traction control system, in particular a method for traction control for a rail vehicle is disclosed, which method predefines a torque setpoint value (Mₛₑₜₚ) for a motor control unit, embodied as a torque control unit (3), by means of a wheel-slip control unit (1) and reduces the torque setpoint value (Mₛₑₜₚ) by means of the wheel-slip control unit (1) when a predefinable threshold value of a differential rotational speed value (Δn), formed from a present rotational speed value (n) and a calculated reference rotational speed value, of a drive motor of a wheel set is reached. In addition, a stator frequency value (f_{S}) is predefined for at least one drive motor, embodied as an asynchronous machine, of a wheel set of the rail vehicle, the stator frequency value (f_{S}) being limited to a stator-frequency-dependent limiting value (f_{SG}) when a maximum frictional engagement between the wheel set and rail is reached. In addition a device for carrying out the method is disclosed. P112017

### DESCRIPTION

1. Field of the invention

The invention relates to the field of drive technology and is based on a method and a device for traction control for a rail vehicle according to the preamble of the independent claims.

2. Prior art

In electrically driven rail vehicles with their torque-controlled drive motors, in particular with asynchronous machines, slip states between the drive wheels and rail may occur in which the drive wheels spin in a more or less uncontrolled fashion. This results in an unstable operation of the vehicle drive in which the maximum possible frictional engagement between the drive wheels and rail is not achieved. In addition, the drive wheels and the rail are subjected to increased wear. The proposed solution to this problem is given in DE 197 27 507 A1. In said publication, a motor control unit is disclosed which is embodied as a torque control unit. This torque control unit is subordinate to a wheel-slip control unit which has the function of minimizing the slip between the wheel and rail when the traction force of the rail vehicle is at a maximum.

A wheel-slip control unit which is used above and is customary today generates, at the output, a setpoint traction force value, or a torque setpoint value which is correlated thereto, and said value is fed to the torque control unit. Given a traction force value which is, for example, preselected by a locomotive driver, the wheel-slip control unit increases the torque setpoint value and subsequently keeps it constant at a specific value. In order to adjust the torque actual value of the rotor of the drive motor to the torque setpoint value predefined by the wheel-slip control unit, the torque control unit adapts the stator frequency value of the drive motor which is embodied as an asynchronous machine. The rotational speed value of the wheel set driven by the drive motor is adapted in parallel with this. If the torque actual value is adjusted to the torque setpoint value, a constant rotational speed value of the driven wheel set is established.

When there are changes in the rail conditions, such as may occur as a result of weather phenomena and/or due to soiling, for example in a bend in the track, the maximum frictional engagement between the wheel set and rail may be reached within a short time, with the maximum frictional engagement being reduced in this short time, i.e. the load torque between the wheel and rail, and thus the torque actual value, becomes smaller than the impressed torque setpoint value of the rotor, as a result of which the wheel set is accelerated. This means that the rotational speed value of the wheel set increases. In order to adjust the torque actual value to the torque setpoint value impressed on the torque control unit, the torque control unit increases the stator frequency value of the drive motor, in which case the rotational speed value is also increased. If a differential rotational speed value, i.e. the difference between the instantaneous rotational speed value of the wheel set and a calculated reference rotational speed value, reaches a predefined threshold value, the wheel-slip control unit typically reduces the torque setpoint value directly to a predefinable value, or reduces it incrementally over a plurality of predefinable values because differential rotational speed values significantly greater than zero are a sign of the presence of slip between the wheel set and rail.

Owing to this reduction in the torque setpoint value which, as already mentioned, is fed to the torque control unit, the torque control unit reduces the stator frequency value, with the result that the drive motor is braked, and the torque actual value can thus be adjusted to the torque setpoint value.

A problem with such influencing measures is that the wheel-slip control does not reduce the torque setpoint value until the threshold value of the differential rotational speed is reached. However, in particular when the rail vehicle is started up and there are associated rapid changes in acceleration of the drive motor, slip states between the wheel set and rail may occur, with the result that the drive wheels and the rails can experience an intolerable degree of wear. If the torque setpoint value is finally reduced when the differential rotational speed threshold value is reached, this reduction is in the order of magnitude of 50% of the previous torque setpoint value. In the case of such drastic interventions by the wheel-slip control unit the stator frequency control reacts very quickly to the reduced torque setpoint value predefined for it by reducing the stator frequency, which may result in very large mechanical stresses on the drive motor, the mechanical units connected to it, for example, the gearbox, and the coupling hooks. A suitable traction control system, in particular a method and a device for carrying out the method to solve the problems mentioned above is currently not known.

### DESCRIPTION OF THE INVENTION

The object of the present invention is therefore to disclose a method for traction control for a rail vehicle, by means of which the slip between the rail and wheel set is minimized with simultaneous low mechanical stressing of the entire drive train, in particular even when the vehicle is starting up, and to disclose a device with which the method is carried out. This object is achieved by means of the features of the independent claims. Advantageous developments of the invention are disclosed in the subclaims.

In the method according to the invention, a torque setpoint value is predefined by means of a wheel-slip control unit for a torque control unit which predefines a stator frequency value for a drive motor, the torque setpoint value being reduced when a predefinable threshold value of a differential rotational speed value which is formed is reached. According to the invention, the stator frequency value is reduced to a stator-frequency-dependent limiting value when a differential rotational speed value is lower than the differential rotational speed value and when a maximum frictional engagement between wheel set and rail is reached. As a result, it is ensured in an extremely advantageous way that, in particular when starting up and when there are rapid changes in acceleration of the drive motor, in particular before the differential rotational speed threshold value is reached, the drive motor is not accelerated further when slip states begin to occur, so that it is not braked heavily by the wheel-slip control unit as a result of a reduction in the torque setpoint value. Therefore, in particular when starting up the vehicle and when there are possible rapid changes in acceleration of the drive motor, the situation is avoided in which the wheel slip control unit drastically reduces the torque setpoint value when the differential rotational speed value is reached. In this way, mechanical stressing of the drive motor and the mechanical unit connected to it, for example the gearbox and coupling hooks, is advantageously reduced.

Furthermore, according to the invention the torque setpoint value is adjusted to the current torque actual value during the limiting of the stator frequency value. As a result, the stator frequency value is adjusted out of the limiting range, with the result that the traction control can change over from the limiting state back into the control state by virtue of the renewed predefinition of the torque setpoint value for the torque control unit by means of the wheel-slip control unit and by virtue of the predefinition of the stator frequency value for the drive motor by means of the torque control unit. The slip, and thus the wear between the wheel set and rail, can thus advantageously be reduced to a minimum because, after the limiting of the stator frequency value, the system can change over immediately into the controlled state of the traction control system without the traction control being disrupted by current drastic interventions in the form of reductions in the torque setpoint value.

The device according to the invention for carrying out the method has a limiting unit which, when the differential rotational speed value is less than the differential rotational speed threshold value and when a maximum frictional engagement between the wheel set and rail is reached, limits the stator frequency value to the stator-frequency-dependent limiting value fed to the limiting unit. Furthermore, a switch-over unit which is controlled by a resetting signal is connected to the torque control unit, the limiting unit being connected to the switch-over unit by outputting the resetting signal when the maximum frictional engagement is reached and when the differential rotational speed value is less than the differential rotational speed threshold value. This easily ensures that the stator frequency value is reduced when a differential rotational speed value is less than the differential rotational speed threshold value and when a maximum frictional engagement is reached, and that the torque setpoint value is adjusted to the current torque actual value with the outputting of the resetting signal to the switch-over unit.

Furthermore, a device is advantageously constructed which by virtue of its simple design which requires few elements, can be implemented both with discrete components and, for example, in a digital microprocessor. This thus provides a simple and cost-effective solution which can additionally be implemented in variable ways and adapted to a wide variety of drive motors.

This and further objects, advantages and features of the present invention will become apparent from the following description of a preferred exemplary embodiment of the invention.

### BRIEF DESCRIPTION OF THE DRAWINGS

The invention will be explained in more detail below with reference to an exemplary embodiment and in conjunction with the drawings, in which:

FIG. 1 shows an embodiment of a device according to the invention for carrying out the method for traction control for a rail vehicle,

FIG. 2 shows a flowchart of a method according to the invention for traction control for a rail vehicle, and

FIG. 3 shows a frictional engagement characteristic curve.

Identical parts are provided with identical reference symbols in the figures in all cases.

### EMBODIMENTS OF THE INVENTION

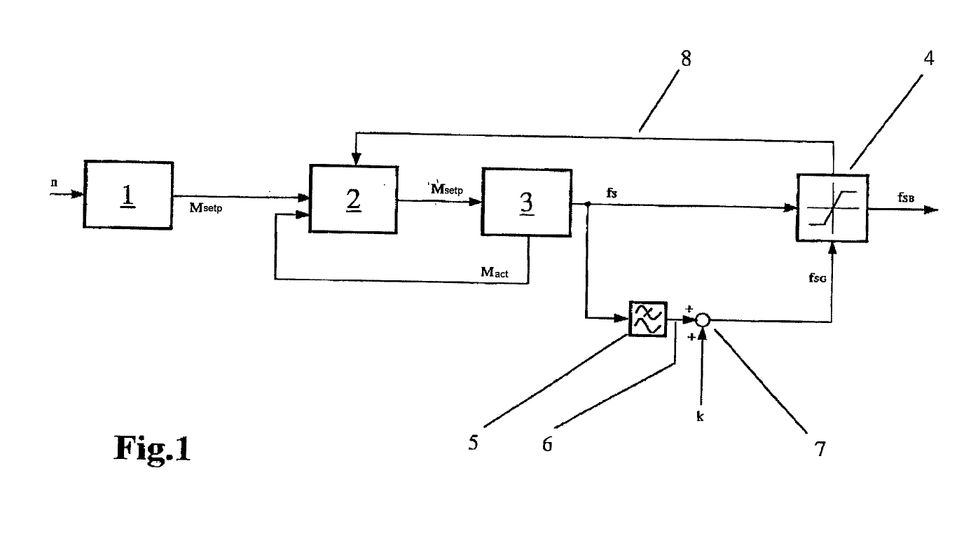

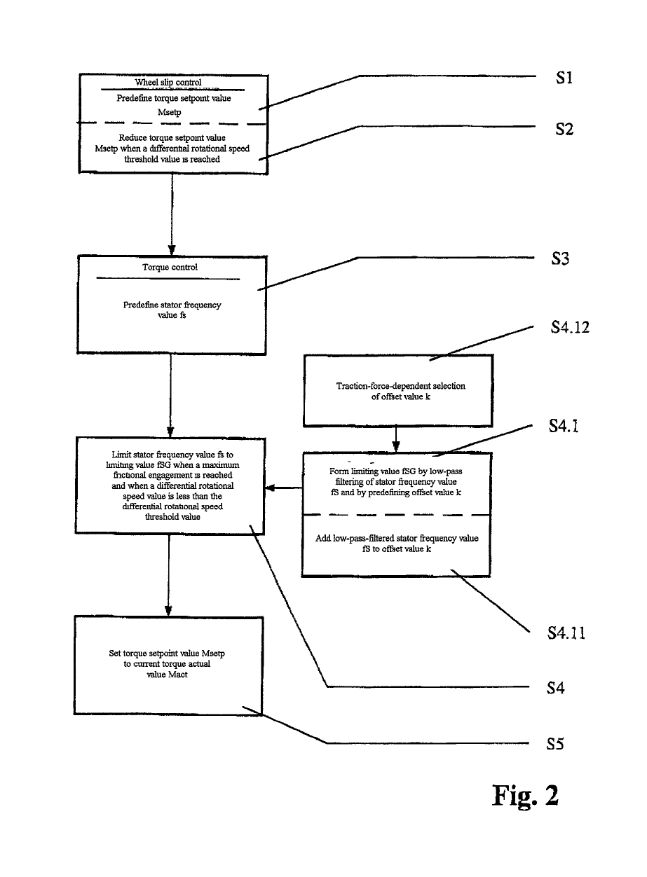

FIG. 1 shows an embodiment of the device according to the invention for carrying out the method for traction control for a rail vehicle. In addition, FIG. 2 shows a flowchart of the method according to the invention for traction control for a rail vehicle.

The device according to FIG. 1 comprises a wheel-slip control unit 1 to which a value of a present rotational speed (n) of a drive motor of a wheel set is fed. The wheel-slip control unit 1 is superordinate to a motor control unit which is embodied as a torque control unit 3.

According to the flowchart of the method according to the invention shown in FIG. 2, the wheel-slip control unit 1 of the torque control unit 3 predefines a torque setpoint value (Mₛₑₜ) in a first method step (SI). This predefinition results, according to the inventive device shown in FIG. 1, in an indirect connection between the torque control unit 3 and the wheel-slip control unit 1.

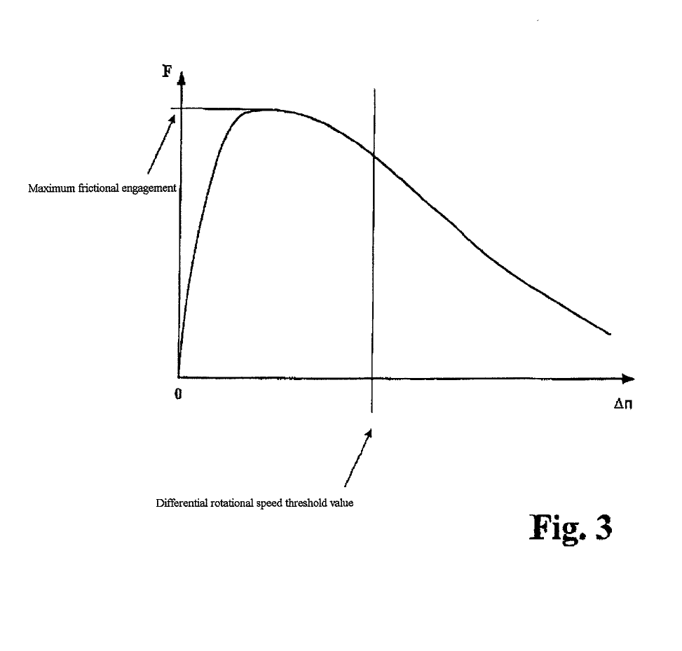

FIG. 3 shows a typical frictional engagement characteristic curve in which the force F between the wheel and rail (frictional engagement) is plotted against a differential rotational speed value (Δn). The differential rotational speed value (Δn) is significantly greater than zero, there is slip between the wheel set and rail. In addition, a predefinable threshold value of the differential rotational speed (Δn) is indicated in FIG. 3. In a further method step (S2) according to FIG. 2, the differential rotational speed value (Δn) is formed, by the wheel-slip control unit 1, from the rotational speed value (n) and a reference rotational speed value calculated in the wheel-slip control unit 1. When the predefinable differential rotational speed threshold value indicated in FIG. 3 is reached, the wheel-slip control unit 1 reduces the torque setpoint value (Mₛₑₜₚ). This torque setpoint value (Mₛₑₜₚ) is present, according to FIG. 1, at the output of the wheel-slip control unit 1.

Furthermore, the torque control unit 3 predefines, in a further method step (3) according to FIG. 2, for at least one drive motor, embodied as an asynchronous machine, of a wheel set of the rail vehicle, a stator frequency value (f_{S}) which is present, according to FIG. 1, at the output of the torque control unit 3. The torque control unit 3 reacts to the reduced torque setpoint value (Mₛₑₜₚ) with the outputting of a reduced stator frequency value (f_{S}) in order to brake the drive motor.

According to the invention, in an additional method step (S4) according to FIG. 2, the stator frequency value (f_{S}) is reduced to a stator-frequency-dependent limiting value (f_{SG}) when a differential rotational speed value (Δn) is lower than the differential rotational speed threshold value and when a maximum frictional engagement between the wheel set and wheel is reached. According to FIG. 1, for this purpose a limiting unit 4 is provided according to the invention, to which limiting unit 4 the stator frequency value (f_{S}) and the stator-frequency-dependent limiting value (f_{SG}) are fed, a limited stator frequency value (f_{SB}) being present at the output of the limiting unit 4. The limited stator frequency value (f_{SB}) is fed to a modulator unit (not shown for the sake of clarity) which generates corresponding signals for a drive power inverter which feeds the drive motor, the modulator unit being connected to the drive power inverter. The limitation of the stator frequency value (f_{S}) on the basis of the criterion mentioned above prevents the drive motor being accelerated further, and thus considerable slip occurring between wheel set and rail with the associated wear when there are rapid changes in acceleration of the drive motor, such as can occur in particular when the rail vehicle is started up. In addition, drastic reductions in the torque setpoint value (Mₛₑₜₚ) are prevented by the wheel-slip control unit 1, advantageously enabling the mechanical stressing of the entire drive train, and of the coupling hooks for example, to be minimized.

In addition, according to FIG. 2, the stator-frequency-dependent limiting value (f_{SG}) is formed (S4.1) by means of a low-pass filter 5 provided for low-pass filtering and by means of a predefinition of an offset value (k). The low-pass-filtered stator frequency value 6 which is present at the output of the low-pass filter 5 is fed, together with the offset value (k) according to FIG. 1, to a summing unit 7 which forms the stator-frequency-dependent limiting value (f_{SG}) according to FIG. 2 (S4.11) by adding the two supplied values. The advantage of the formation, described above, of the stator-frequency-dependent limiting value (f_{SG}) lies in the fact that the stator frequency value (f_{S}) is subject to variable limitation, in particular as a function of its own value. The selection of the offset value (k) also makes it possible for the bandwidth within which the limitation of the stator frequency value (f_{S}) can vary to be set. The offset value (k) according to FIG. 2 is preferably selected (S4.12) here as a function of the traction force, i.e. a low value for low requested traction forces because the possibility of a slip state is quite small and the bandwidth of the limitation of the stator frequency value (f_{S}) can thus also be kept within tight limits. On the other hand, when there are large requested traction forces, a large value is advantageously selected for the offset value (k) because slip states are very probable, and the bandwidth of the limitation of the stator frequency value (f_{S}) can thus be kept large.

According to FIG. 1, a switch-over unit 2 is arranged between the wheel-slip control unit 1 and the torque control unit 3. The switch-over unit 2 is connected at its input to the wheel-slip control unit 1, the torque setpoint value (Mₛₑₜₚ) being present at the input of the switch-over unit 2 and at its output. In addition, the switch-over unit 2 is connected by its output to the torque control unit 2. The limiting unit 4 outputs a resetting signal 8 when the maximum frictional engagement between the wheel set and rail is reached and when a differential rotational speed value (Δn) is lower than the differential rotational speed threshold value, the limiting unit 4 being connected to the switch-over unit 2 by means of the outputting of the resetting signal 8. The switch-over unit 2 is thus actuated by means of the resetting signal 8 during the limitation of the stator frequency value (f_{S}) by the limiting unit 4 on the basis of the criterion mentioned above. As a result of this actuation by means of the resetting signal 8, the switch-over unit 2 sets, according to FIG. 2, the torque setpoint value (Mₛₑₜₚ) present at its input to a current torque actual value (M_{act}) which is fed to a further input. The setting of the torque setpoint value (Mₛₑₜ) to the current torque actual value (M_{act}) during the limitation of the stator frequency value (f_{S}) ensures in a very easy way that the stator frequency value (f_{S}) is adjusted out of the limiting value, with the result that the traction control can change over from limiting the stator frequency value (f_{S}) back into the control state described at the beginning. The traction control is thus outside the control state for only a very short time and is additionally not influenced by current drastic interventions in the form of reductions in the torque setpoint value (Mₛₑₜ) by the wheel-slip control unit, in particular when starting up and in the case of rapid acceleration changes of the drive motor. The slip between the wheel set and the rail and the associated wear is thus further reduced.

The current torque actual value (M_{act}) which is fed to the switch-over unit 2 is obtained from a conventional drive motor sensor system (not explained in more detail) or estimated by means of a control observer, but is present, according to the invention, at a further output of the torque control unit 3 because the current torque actual value (M_{act}) is already present at the torque control unit 3 for control purposes with the result that additional cost-intensive signal routing and signal transmission can be dispensed with. Furthermore, the switch-over unit 2 is advantageously a resettable integrator which can be implemented particularly easy with discrete parts or as a digital component.

According to the invention, the device for carrying out the method can be implemented in at least one digital microprocessor (not illustrated), with the result that discrete parts can advantageously be dispensed with and adaptation of the device to drive motors in a wide variety of applications is facilitated, and thus can be carried out easily.

Of course, the device for carrying out the method is provided both for a single respective drive motor and for a plurality of drive motors together.

In addition, it is a self-evident that blocks, signals and values other than those specified in the exemplary embodiment can be used.

1. Method for traction control for a rail vehicle comprising the steps
(S1) predefining a torque setpoint value (Mₛₑₜ) for a motor control unit, embodied as a torque control unit (3), by means of a wheel-slip control unit (1), and
(S2) reducing the torque setpoint value (Mₛₑₜ) by means of the wheel-slip control unit (1) when a predefinable threshold value of a differential rotational speed value (Δn), formed from a present rotational speed value (n) and a calculated reference rotational speed value, of a drive motor of a wheel set is reached,
(S3) the torque control unit (3) predefining a stator frequency value (f_{S}) for at least one drive motor, embodied as an asynchronous machine, of a wheel set of the rail vehicle, characterized by the further step
(S4) limiting of the stator frequency value (f_{S}) to a stator-frequency-dependent limiting value (f_{SG}) when a differential rotational speed value (Δn) is less than the differential rotational speed threshold value and when a maximum frictional engagement between the wheel set and rail is reached.

2. Method according to claim 1, characterized by the further step
(S4.1) forming of the stator-frequency-dependent limiting value (f_{SG}) by means of low-pass filtering of the stator frequency value (f_{S}) and by means of a predefining an offset value (k).

3. Method according to claim 2, characterized by the further step
(S4.11) adding the low-pass-filtered stator frequency value (6) to the offset value (k).

4. Method according to claim 2, characterized by the further step
(S4.12) traction-force-dependent selecting the offset value (k).

5. Method according to claim 1, characterized by the further step
(S5) setting of the torque setpoint value (Mₛₑₜ) to the current torque actual value (M_{act}) during the limitation of the stator frequency value (f_{S}).

6. Device for traction control for a rail vehicle having a motor control unit, embodied as a torque control unit (3), and a wheel-slip control unit (1), the wheel-slip control unit (1) being indirectly connected to the torque control unit (3) by predefining a torque setpoint value (Mₛₑₜ), and a stator frequency value (f_{S}) being present at the output of the torque control unit (3), and a reduced torque setpoint value (Mₛₑₜ) being present at the output of the wheel-slip control unit (1) when a predefinable threshold value of a differential rotational speed value (Δn) formed from a present rotational speed value (n) of a drive motor of a wheel set and from a calculated reference rotational speed value is reached, characterized in that a limiting unit (4) is provided which, when a differential rotational speed value (Δn) is less than the differential rotational speed threshold value and when a maximum frictional engagement between the wheel set and rail is achieved, limits the stator frequency value (f_{S}) to a stator-frequency-dependent limiting value (f_{SG}) which is fed to the limiting unit (4).

7. Device according to claim 6, characterized in that a limited stator frequency value (f_{SB}) is present at the output of the limiting unit (4).

8. Device according to claim 6, characterized in that the stator frequency value (f_{S}) is fed to a low-pass filter (5).

9. Device according to claim 8, characterized in that a low-pass-filtered stator frequency value (6) which is present at the output of the low-pass filter (5), and an offset value (k), are fed to a summing unit (7) in order to form the stator-frequency-dependent limiting value (f_{SG}).

10. Device according to claim 6, characterized in that a switch-over unit (2) controlled by a resetting signal (8) is connected to the torque control unit (3), the torque setpoint value (Mₛₑₜ) being present at the output of the switch-over unit (2).

11. Device according to claim 10, characterized in that the switch-over unit (2) is a resettable integrator.

12. Device according to claim 10, characterized in that the limiting unit (4) is connected to the switch-over unit (2) by outputting the resetting signal (8) when the maximum frictional engagement is reached and when the differential rotational speed value (Δn) is less than the differential rotational speed threshold value.

13. Device according to claim 10, characterized in that the switch-over unit (2) is connected at its input to the wheel-slip control unit (1), the torque setpoint value (Mₛₑₜ) being present at the input of the switch-over unit (2).

14. Device according to claim 13, characterized in that a current torque actual value (M_{act}) is fed to a further input of the switch-over unit (2).

15. Device according to claim 14, characterized in that the current torque actual value (M_{act}) is present at a further output of the torque control unit (3).

16. Device according to one of claims 6 to 15, characterized in that the device is implemented in at least one digital microprocessor.
